(19) United States
(12) Patent Application Publication
(10) Pub. No.: US 2025/0157320 A1
(43) Pub. Date: May 15, 2025

(54) INTELLIGENT PROTECTION SWITCH SYSTEM AND ITS APPLIED MOLDED CASE CIRCUIT BREAKERS AND SOCKETS

(71) Applicants: PENG-HSUN LU, Taichung City (TW); TENG-SHAO LU, Taichung City (TW)

(72) Inventors: PENG-HSUN LU, Taichung City (TW); TENG-SHAO LU, Taichung City (TW)

(21) Appl. No.: 18/508,196

(22) Filed: Nov. 13, 2023

(51) Int. Cl. G08C 17/00; H02H 1/00

(52) U.S. Cl. CPC G08C 17/00; H02H 1/0061

(57) ABSTRACT

An intelligent protection switch system and molded case circuit breaker and socket thereof are provided, and includes: a housing, non-power/battery controller assembled in the housing, and a wireless receiving module. The non-power/battery controller includes: a bracket assembled on the housing; an electromagnetic induction coil and first and second magnetic plates assembled on the bracket; an linkage guide plate assembled in the housing in a pressable state, and kept a distance from the first and second magnetic plates; and a first control circuit. The wireless module is assembled on the electrical equipment, and includes a second control circuit and router. With the above structure, once the linked guide plate is pressed, the first control circuit forms a closed loop, and generates an induced current and sends out an on/off digital signal received through the router and the second control circuit, to control on/off of the power loop of the electrical equipment.

### BACKGROUND OF THE INVENTION

### Field of the Invention

The invention relates to a protective switch system, and more particularly, to an intelligent protective switch system equipped with a non-power/battery controller as well as a wireless receiving module, which can remotely control the turning on or off of the circuits of an electrical equipment, such as those used for electrical circuits of a socket, lighting, microwave oven, air conditioner in buildings, so as to achieve convenient, safe and comfortable experience of the intelligent protective switch, and the molded case circuit breaker and socket applied thereto.

### Description of the Prior Art

In recent days, with the development of communications and Internet in modern technologies, with the wireless transmission capability, a controller can remotely control electrical equipment, such as controlling the turning on or off power loop of a lighting device, socket, air conditioner, motor, etc., while meeting the needs for safety, convenience, environmental friendliness, green energy, and are thus considered as mature designs. However, a prior art controller can only control the turning on or off of the power loop of the electrical equipment when powered on. Once the controller is out of power, it cannot control the turning on or off of the power loop of the is powered off, it cannot control the turning on or off of the power loop through wireless transmission.

Furthermore, the safety of electrical equipment is one of the most important safety issues in daily life. As acknowledged in consensus nowadays, in industrial, commercial or domestic use of electrical equipment, the power loop is controlled by a Molded-case circuit breaker (MCCB) in the power switch box manually, so as to achieve the power on-off control of the electrical equipment. Although this manual mode is simple to operate, it also brings inconvenience in field operation. For example, if the circuits cannot be disconnected due to some reasons (over-current and leakage), there will be concerns about the safety of electrical equipment. In addition, the possibility of electric shock will be greatly increased by directly operating the molded case circuit breaker manually.

### SUMMARY OF THE INVENTION

The purpose of this creation is to provide an intelligent protection switch system, which can remotely control the turning on or off of the power loop of the electrical equipment without the need for sending the enabling and disabling digital signals, which are revied by the non-power/battery controller of the electrical equipment, so as to improve the conveniency, safety and help create a comfortable environment for using the electrical equipment without laying out the control pipelines and actual layout traces of the electrical equipment before construction, and the present invention also improves the user experience and provides a safe and comfortable power environment.

Another purpose of the present intelligent protection switch system is that the wireless receiving module in the intelligent protection switch system can be connected to smart phones, tablets, desktops and other terminal devices for monitoring through the network, and can directly control the turning on or off of the power loop of electrical equipment through the network, making it more convenient and comfortable to use.

In order to achieve the above purpose, the intelligent protection switch system of the present invention includes: a housing; a non-power/battery controller assembled in the housing; and a wireless receiving module.

The non-power/battery controller comprises: at least one bracket assembled on the housing; an electromagnetic induction coil and first and second magnetic plates assembled on the bracket; an linkage guide plate assembled in the housing in a pressable state, wherein a pressable end of the linkage guide plate is kept a distance from one end of the first and second magnetic plates, and once the pressable end of the linkage guide plate is pressed, it communicates with the first and second magnetic plates; and a first control circuit, wherein the first and second magnetic plates are connected with the electromagnetic induction coil. The first and second magnetic plates are connected with the electromagnetic induction coil. The first control circuit is a digital circuit chip, and is provided with a power loop circuit and an on-off digital signal by programmable logic; the power loop circuit has at least an input contact terminal, which is communicated with the first and second magnetic plates.

With the above structure, once the pressable end of the linkage guide plate is pressed to contact with the first and second magnetic plates, the circuit loop of the first control circuit will form a closed loop, thereby generating digital signals for turning on or off.

The wireless receiving module is assembled on the electrical equipment, and comprises a second control circuit and a router, wherein the second control circuit is designed by programmable logic, is a receiving circuit for receiving the on-off digital signal of the first control circuit, and is connected with the router. The router is arranged to receive the on-off digital signal of the first control circuit and transmit it to the second control circuit to control the on-off state of the power loop of the electrical equipment.

According to the above, the wireless receiving module further includes a data storage connected to the second control circuit and connected to terminals such as mobile phones, tablets, desktops, etc. through the network, for storing and monitoring the startup and shutdown messages of the power loop of the electrical equipment, and can directly control the startup or shutdown of the power loop of the electrical equipment through the terminal device through the router.

### BRIEF DESCRIPTION OF THE DRAWINGS

FIG. 1 is a perspective exploded view of a non-power/battery controller for creating an intelligent protection switch system.

FIG. 1A is an assembled side view of FIG. 1.

FIG. 2 is a first control circuit diagram of the present invention intelligent protection switch system.

FIG. 3 is the second control circuit diagram of the present invention intelligent protection switch system.

FIG. 4 is a block flowchart illustrating an inventive intelligent protection switch system according to the first embodiment of the present invention.

FIG. 5 to FIG. 9 are a block flowchart, relay driving circuit diagram, and external views of molded case circuit breakers and sockets of the second embodiment of the present invention intelligent protection switch system applied to molded case circuit breakers and sockets.

### DETAILED DESCRIPTION OF THE INVENTION

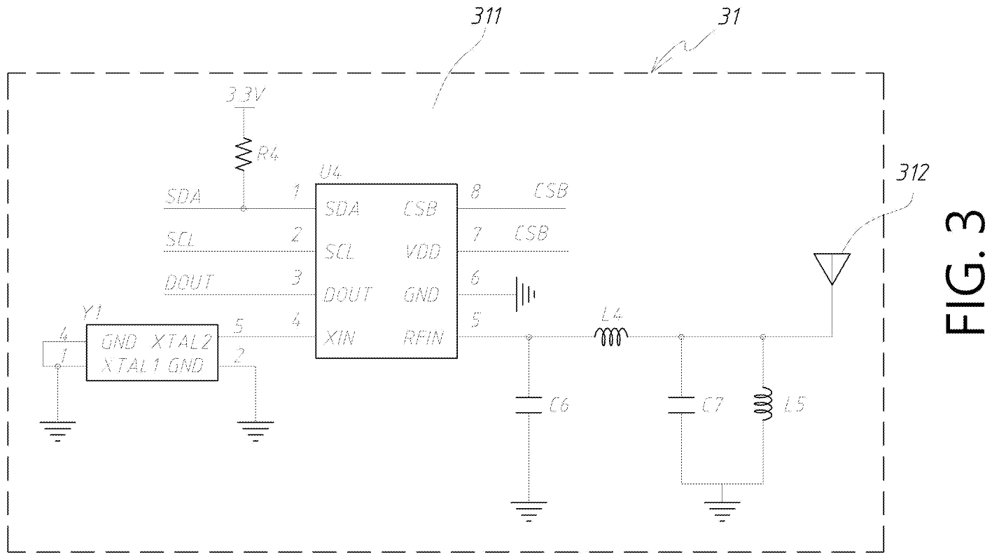

Please refer to FIG. 4, which is a block flowchart illustrating an intelligent protection switch system according to a first embodiment of the present invention. The intelligent protection switch system 1 combines a non-power/battery controller 2 with a wireless receiving module 3, and utilizes the signal transmission to cooperate with the wireless receiving module 3 installed in the electrical equipment, so as to perform wireless control of turning on/off of the power loop 41 of the electrical equipment.

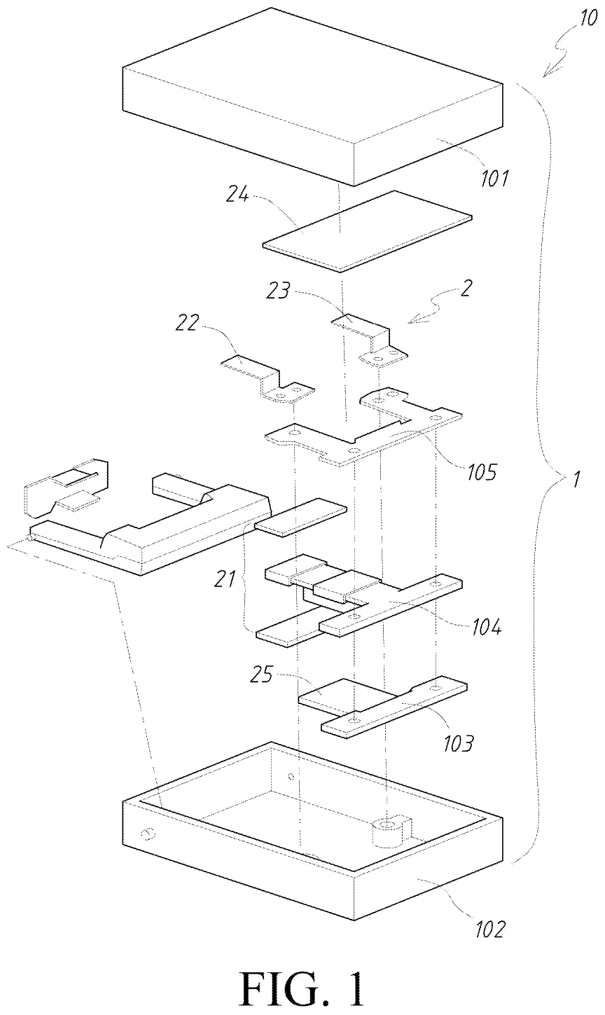

Regarding the structures of the non-power/battery controller 2 and the wireless receiving module 3 of the present invention, please further refer to the description of FIGS. 1 to 3. As shown in FIG. 1, the intelligent protection switch system 1 of the present invention comprises a housing 10 which is integrated by an upper box 101 and a lower box 102, a first bracket 103, a second bracket 104 and a third bracket 105 arranged in the housing 10 for assembling the non-power/battery controller 2.

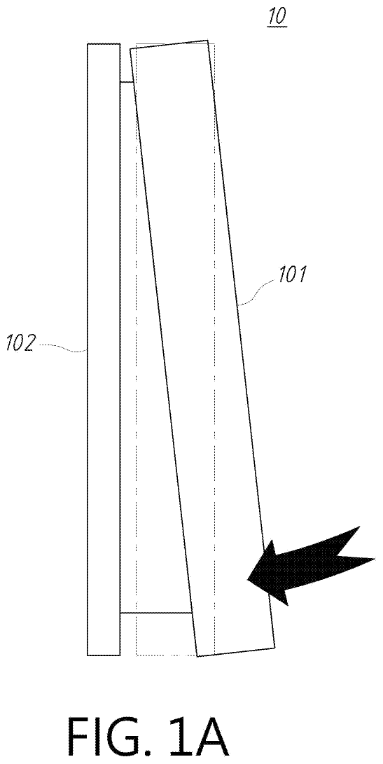

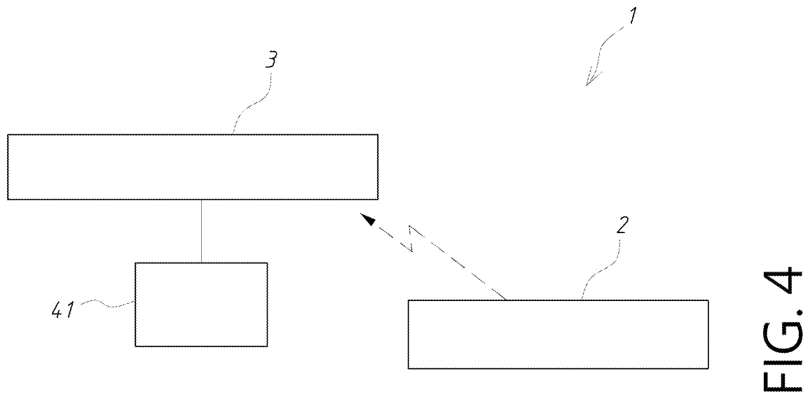

As shown in FIGS. 1 and 2, the wireless controller 2 includes an electromagnetic induction coil 21, first and second magnetic plates 22 and 23, and a linkage plate 24, and a first control circuit 25, wherein the first control circuit 25 is assembled and fixed on the first bracket 103. The electromagnetic induction coil 21 is assembled and fixed on the second bracket 104. The first and second magnetic plates 22 and 23 are assembled in the third bracket 105 and connected with the electromagnetic induction coil 21. The linkage plate 24 is assembled on the housing 10 in a pressable state, and the pressable end of the linkage guide plate 24 keeps a distance from one end of the first and second magnetic plates 22, 23. Once the pressable end of the linkage guide plate 24 is pressed, that is, one end of the upper box 101 is pressed, the linkage plate 24 is linked with the first and second magnetic plates 22, 23. The first control circuit 25 is a digital circuit chip as shown in FIG. 2, and is provided with a power loop circuit 251 and an on-off digital signal 252 by programmable logic. The power loop circuit 251 has an input contact terminal 253, which is communicated with the first and second magnetic plates 22, 23. When the linkage guide plate 24 is contacted with the first and second magnetic plates 22, 23, the circuit loop of the first control circuit 25 forms a closed loop and generates induction current, and transmits the on-off digital signal 252 (as shown in FIG. 2) to be received by the wireless receiving module 3. In addition, as shown in FIG. 2, the first control circuit 25 further includes an alarm circuit 254, which is wirelessly connected with the data storage 32 in FIG. 5 and transmits an alarm signal once the data storage 32 monitors that the power loop of the electric equipment is turned on or off.

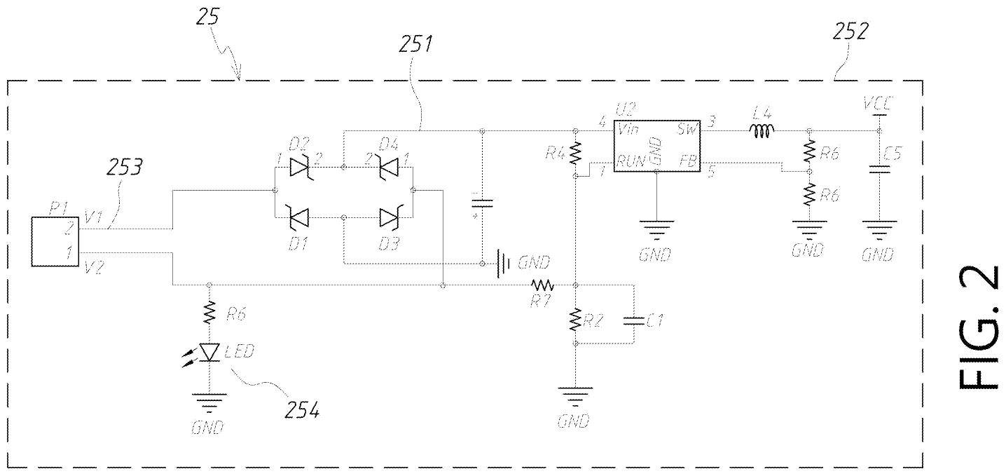

Please refer to FIG. 5 in conjunction with FIG. 3 and FIG. 4. The wireless receiving module 3 is assembled on the electrical equipment 4 and comprises a second control circuit 31 and a router 32, wherein the second control circuit 31 is provided with programmable logic as shown in FIG. 3, and is used for receiving the on-off digital signal 252 of the first control circuit 25, and has a receiving terminal 312 wirelessly connected with the router 32. The router 32 is arranged to receive the on-off digital signal 252 of the first control circuit 25 and transmit it to the second control circuit 31 through the receiving terminal 312 to control the on-off state of the power loop 41 of the electric equipment 4.

According to the structures of the wireless receiver module 3 and the wireless controller 2, the intelligent protection switch system 1 of the first embodiment of the present invention can wirelessly turn on or off the power loop 41 of the electrical equipment through signal transmission and cooperate with the wireless receiver module 3 assembled in the electrical equipment 4, regardless of whether there is affection from the power supply.

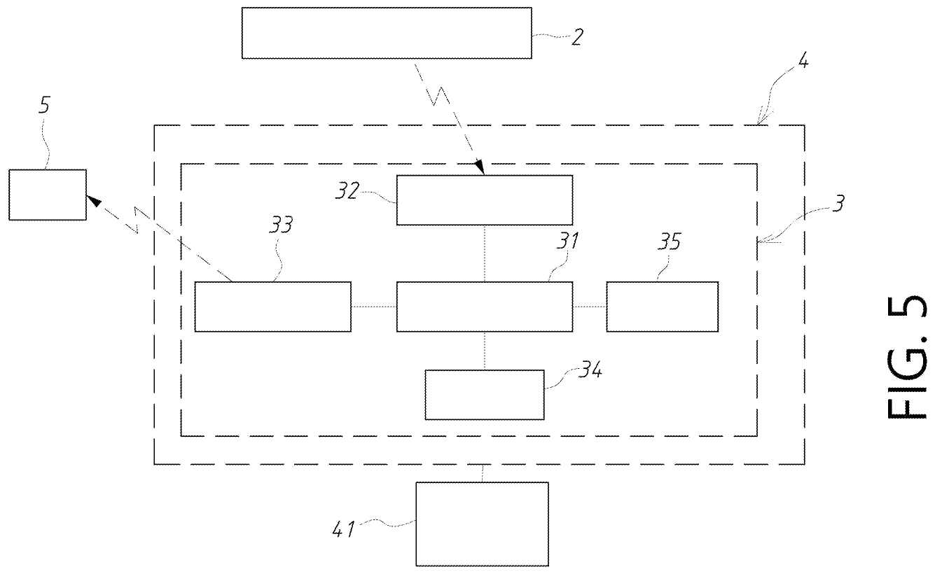

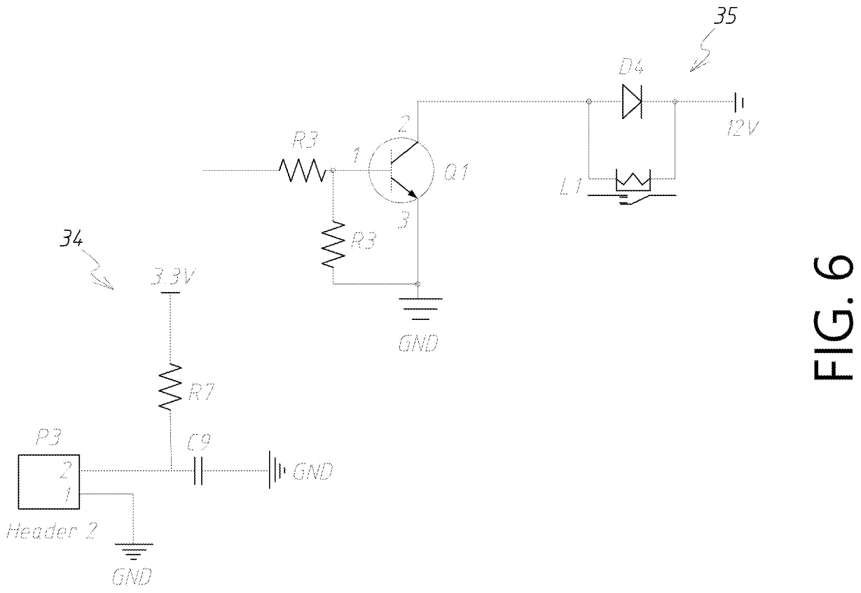

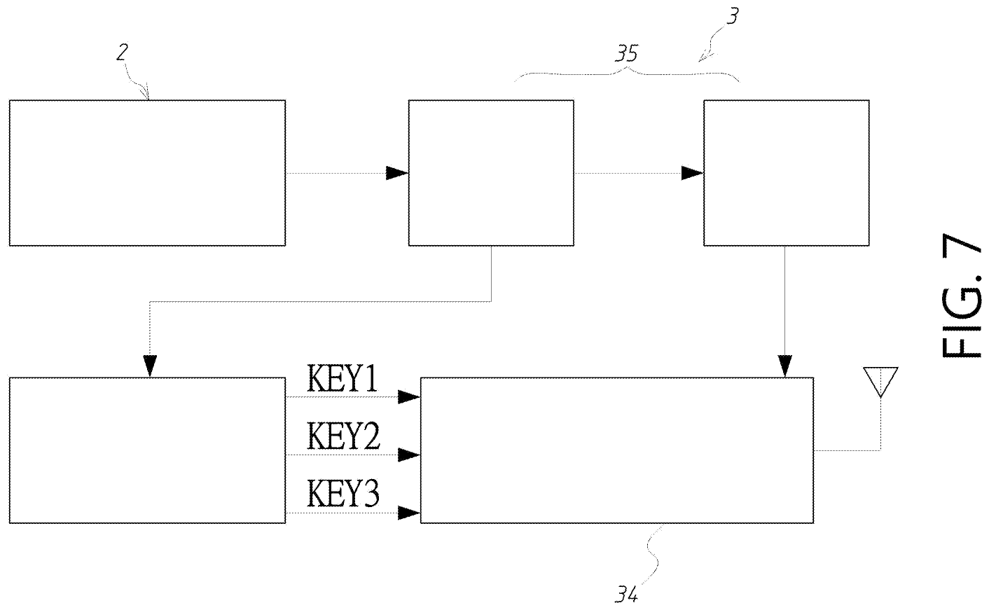

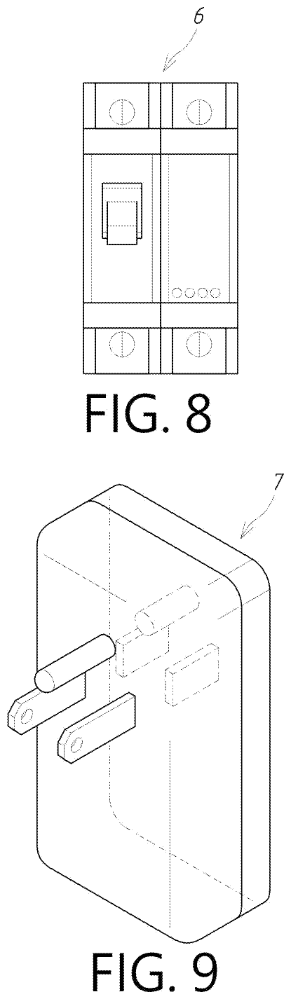

Please refer to FIG. 3 and FIG. 5 to FIG. 9 for the intelligent protection switch system according to the second embodiment of the present invention. The second embodiment is the embodiment in which the intelligent protection switch system 1 is applied to the molded case circuit breaker 6 (see FIG. 8) and the socket 7 (see FIG. 9). As shown in FIG. 5, the second embodiment is different from the first embodiment shown in FIG. 4, except for the structures of the wireless receiving module 3 and the wireless controller 2. The different between the two embodiments can be seen from FIGS. 5 and 6, where the second control circuit 31 of the wireless receiving module 3 is further connected to a data storage 33, a frequency adjustment circuit 34 and a relay circuit 35. The data storage 33 is connected to the second control circuit 31 and can be connected to a terminal device 5 such as a mobile phone, a tablet computer and a desktop computer through a network, and is arranged to store and monitor the startup and shutdown messages of the power loop of the electrical equipment, that is, the startup or shutdown of the power loop of the electrical equipment can be directly controlled by the terminal device 5 through the router 32. The frequency adjustment circuit 34 is arranged to set the operating power frequency of the power loop of a specific electrical equipment. The relay circuit 35 is arranged to modulate the current within limitation of the power loop of a specific electrical equipment. In this way, before intelligent protection switch system of the present invention is applied to the molded case circuit breaker 6 (FIG. 8) for wireless on or off control, the frequency modulation circuit 34 and the relay circuit 35 are utilized with the molded case circuit breaker to perform frequency modulation and adjust current within limitation, and then the non-power/battery controller 2 and the wireless receiving module are utilized such that the same effect of the wireless on or off control over the molded case circuit breaker shown in the aforementioned first embodiment can be achieved. That is to say, as shown in FIG. 7, after the power is generated through electromagnetic induction by the non-power/battery controller 2, the frequency modulation circuit 34 and the relay circuit 35 are further used to set the frequency of the operation power and modulate the current within limitation for the electrical circuit. Further, the wireless receiving module 3 uses a terminal device such as a smartphone, tablet, desktop etc. to directly control turning on or off of the power loop of the molded case circuit breaker, so as to improve the conveniency, safety and help create a comfortable environment for using the electrical equipment without laying out the control pipelines and actual layout traces of the electrical equipment before construction, and the present invention also improves the user experience and provides a safe and comfortable power environment. Similarly, a control method of applying the intelligent protection switch system of this invention to the socket 7 (shown in FIG. 9) can be referred to the content above, and can also provide the effect of convenience, safety and comfort in the use of electricity.

What is claimed is:

1. An intelligent protection switch system comprises: a housing; and a non-power/battery controller assembled in the housing; and a wireless receiving module, wherein:
the non-power/battery controller comprises: at least one bracket assembled on the housing; an electromagnetic induction coil and first and second magnetic plates assembled on the bracket; and an linkage guide plate assembled in the housing in a pressable state, wherein a pressable end of the linkage guide plate is kept a distance from one end of the first and second magnetic plates, and once the pressable end of the linkage guide plate is pressed, it communicates with the first and second magnetic plates; and a first control circuit, wherein the first and second magnetic plates are connected with the electromagnetic induction coil; wherein the first control circuit is a digital circuit chip, and is provided with a power loop circuit and an on-off digital signal by programmable logic; the power loop circuit has at least an input contact terminal, which is communicated with the first and second magnetic plates; when the linkage guide plate is communicated with the first and second magnetic plates, the circuit loop of the first control circuit forms a closed loop, which generates an induced current and transmits the on-off digital signal; and
the wireless receiving module is assembled on an electrical equipment, and comprises a second control circuit and a router, wherein the second control circuit is designed by programmable logic, is a receiving circuit for receiving the on-off digital signal of the first control circuit, and is connected with the router; the router is arranged to receive the on-off digital signal of the first control circuit and transmit the on-off digital signal to the second control circuit to control the on-off state of the power loop of the electrical equipment.

2. The intelligent protection switch system according to claim 1, wherein the second control circuit is further connected with a data storage, which is connected with the second control circuit and connected with a terminal device being one of a mobile phone, tablet and desktop through network, and is arranged to store and monitoring startup and shutdown messages of the power loop of the electric equipment, so as to directly control startup or shutdown of the power loop of the electric equipment through the terminal device through the router.

3. The intelligent protection switch system according to claim 1, wherein the second control circuit is further connected with a frequency adjustment circuit, and the frequency adjustment circuit is arranged to set the operation power frequency of the power loop of a specific electric equipment.

4. The intelligent protection switch system according to claim 2, wherein the second control circuit is further connected with a relay circuit, and the relay circuit is arranged to modulate current within limitation of the power loop of a specific electric equipment.

5. The intelligent protection switch system according to claim 1, wherein the first control circuit further comprises an alarm circuit, which is wirelessly connected with the data storage, and transmits an alarm signal once the data storage monitors that the power loop of the electric equipment is turned on or off.

6. A molded case circuit breaker applicable to the intelligent protection switch system according to claim 1, wherein before the molded case circuit breaker is wirelessly turned on or off, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

7. A molded case circuit breaker applicable to the intelligent protection switch system according to claim 2, wherein before the molded case circuit breaker is turned on or off, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

8. A molded case circuit breaker applicable to the intelligent protection switch system according to claim 3, wherein before the molded case circuit breaker is turned on or off, the frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

9. A molded case circuit breaker applicable to the intelligent protection switch system according to claim 4, wherein before the molded case circuit breaker is turned on or off, a frequency adjustment circuit and the relay circuit are respectively arranged to adjust frequency and adjust current within limitation, and then the non-power/battery controller and the wireless receiving module are respectively arranged to wirelessly control turning on or off of the molded case circuit breaker.

10. A molded case circuit breaker applicable to the intelligent protection switch system according to claim 5, wherein before the molded case circuit breaker is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

11. A socket for the intelligent protection switch system according to claim 1, wherein before the socket is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

12. A socket for the intelligent protection switch system according to claim 2, wherein before the socket is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

13. A socket for the intelligent protection switch system according to claim 3, wherein before the socket is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

14. A socket for the intelligent protection switch system according to claim 4, wherein before the socket is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.

15. A socket for the intelligent protection switch system according to claim 5, wherein before the socket is turned on or off wirelessly, a frequency adjustment circuit and a relay circuit are respectively arranged to adjust frequency and adjust current within limitation, and then the non-power/battery controller and the wireless receiving module are respectively arranged to wirelessly control turning on or off of the molded case circuit breaker.
